(19) United States
(12) Patent Application Publication
(10) Pub. No.: US 2026/0331350 A1
(43) Pub. Date: Oct. 22, 2026

(54) METHOD AND APPARATUS FOR COOLING DEGAUSSING COILS

(71) Applicant: Data Security, Inc., Lincoln, NE (US)

(72) Inventors: Walker Arce, Omaha, NE (US); Leroy Thiel, Lincoln, NE (US)

(21) Appl. No.: 19/652,651

(22) Filed: Apr. 20, 2026

Related U.S. Application Data
(60) Provisional application No. 63/791,845, filed on Apr. 21, 2025.

(51) Int. Cl. H01F 27/08; G11B 5/024; G11B 33/14; H01F 7/20; H01F 27/20

(52) U.S. Cl. CPC H01F 27/085; G11B 5/0245; G11B 33/1413; G11B 33/142; H01F 7/202; H01F 27/20

(57) ABSTRACT

An apparatus for cooling electromagnet degaussing coils includes a cover with an outer casing and an inner casing with internal cavity therebetween. An electromagnet degaussing coil is disposed in the internal cavity. The electromagnet degaussing coil includes a first portion and a second portion disposed opposite the first portion. A first restraint is disposed between the first portion of the coil and the cover. The first restraint forms a first set of restraint channel ribs to support the coil. A second restraint is disposed between the second portion of the coil and the cover. The second restraint forms a second restraint channel and a second set of restraint channel ribs to support the coil. A fan is mounted in fluid communication with the restraint channels for cooling the electromagnet degaussing coil.

### CROSS REFERENCE TO RELATED APPLICATIONS

This application claims priority to U.S. Provisional Application No. 63/791,845, filed Apr. 21, 2025, and is incorporated herein by reference in its entirety.

### TECHNICAL FIELD

This invention relates generally to the electromagnetic erasure of storage media and, in particular, to methods and apparatus for cooling devices that are used for the electromagnetic erasure of storage media.

### BACKGROUND

Magnetic storage media such as hard drives, tapes, and floppy disks are widely used for storing data in various forms. Upon disposal, information stored on the media may be subject to unauthorized access or misuse. Further, certain industries are subjected to regulations that call for data destruction and, as such, organizations may need to ensure proper erasure of media to comply with legal requirements. Thus, it may be desirable to permanently erase the media before disposal.

Degaussers are one type of device that can be used to permanently erase data on magnetic storage media. Degaussers work by using an electromagnet coil to generate a magnetic field to permanently erase data on the magnetic storage media. The coil generates a strong magnetic field when an electric current passes through it. This magnetic field disrupts the alignment of magnetic domains on the media effectively erasing the data.

The strong magnetic field generated by the coil produces a significant amount of heat. If this heat is not dissipated, it can cause the coils to overheat, potentially damaging the degausser and reducing its effectiveness.

### BRIEF DESCRIPTION OF DRAWINGS

The above needs are at least partially met through provision of the electromagnet cooling device described in the following detailed description, particularly when studied in conjunction with the drawings, wherein:

FIG. 1 is an isometric view of an electromagnet degaussing coil with a magnetic storage media, according to some embodiments;

FIG. 2 is a top, front isometric view an electromagnet degaussing coil that is fully enclosed with forced air ventilation to cool the external wire surface of an electromagnet, according to some embodiments;

FIG. 3 is a bottom, rear isometric view of the electromagnet degaussing coil of FIG. 2;

FIG. 4A a top, front isometric view of the electromagnet degaussing coil of FIG. 2 with a portion of the cover removed;

FIG. 4B is a top, isometric view of the inlet diverter of FIG. 4A;

FIG. 4C is a side view of FIG. 4A with the first opening and inlet diverter;

FIG. 5 is a left side view of the electromagnet degaussing coil of FIG. 2;

FIG. 6 is a section view of the electromagnet degaussing coil of FIG. 5 taken along line “I-I”;

FIG. 7 is a section view of the electromagnet degaussing coil of FIG. 5 taken along line “II-II”;

FIG. 8 is a section view of the electromagnet degaussing coil of FIG. 5 taken along line “III-III”;

FIG. 9 is a section view of the electromagnet degaussing coil of FIG. 5 taken along line “IV-IV”;

FIG. 10 is a section view of the electromagnet degaussing coil of FIG. 5 taken along line “V-V”;

FIG. 11 is a section view of FIG. 5 taken along line III-III, with the exhaust duct and external support bars not visible

FIG. 12 is a schematic diagram of an electromagnet wire, according to some embodiments;

FIG. 13 is an isometric view of an electromagnet degaussing coil with internal wire surface cooling, according to some embodiments;

FIG. 14 a top plan view of the electromagnet degaussing coil of FIG. 13;

FIG. 15 is a section view of the electromagnet degaussing coil of FIG. 14 taken along line “VI-VI”; and

FIG. 16 is a section view of the electromagnet degaussing coil of FIG. 14 taken along line “VII-VII”.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The methods and apparatuses provided herein cool an electromagnet degaussing coil, such as those used in a degausser, using a fan for forced air cooling of the coil. The cooling approaches described herein use dual-function channels that are arranged along the electromagnetic degaussing coil. Such dual-function channels distribute cooling fluid to the coils and also act as restraints to resist repulsive forces generated by the coils during degaussing. The channels are disposed within a housing or cover that contains the electromagnet degaussing coil. The channels distribute a cooling fluid, such as ambient air or a refrigerant gas, to the surfaces of electromagnetic wires. In addition, the channels include structural supports for the electromagnet wires that form the coils. Structural supports may be in the form of fins or ribs that are disposed within the channels between the cover and the coil to resist repulsive forces generated by the wires during a degaussing operation. Using channels configured as described herein may address heat generated and flux field forces generated in the electromagnetic degaussing coils.

In some aspects, the cooling approaches described herein employ the restraints in the channels as an inverted heatsink, where the restraint ribs are disposed facing and/or in contact with the component to be cooled (e.g., the coil), creating air passages or cavities for fluid flow between the heatsink and the component. The inverted heatsink configuration creates a heatsink near a proximity of outside and/or inside surfaces of the electromagnet degaussing coil while at the same time restraining and resisting movement of the coil due to magnetic flux fields.

Typically, bulk erasure heads are operated for a period of time until either a fixed number of cycles have passed or a until thermal switch is triggered, at which point operation ceases until the erasure head is at an appropriate temperature. Certain regulations, such as those distributed by the National Security Agency (NSA), call for magnetic degaussers to operate above 3 Tesla continuously for one hour with three cooling periods allowed during the one-hour time period, erasing a minimum of about forty magnetic media devices, which amounts to an average erasure time of about 1.5 minutes. However, it may be desirable to reduce the average erasure time from about 1.5 minutes to about 10 seconds. Additionally, as the magnetic field requirements for erasing storage media increase due to the introduction of new storage media, cooling degaussing coils may become more challenging. The cooling approaches described herein may extend the operating time interval for electromagnet degaussing coils that are operated at higher electrical energy levels. Thus, the cooling apparatuses and methods described herein may allow for operation of electromagnets to maintain a desired magnetic field strength and allow high volumes of media to be processed for extended periods of time.

In some aspects, an apparatus for cooling electromagnet degaussing coils comprises a cover that includes an outer casing and an inner casing with internal cavity therebetween. An electromagnet degaussing coil is disposed in the internal cavity. The electromagnet degaussing coil includes a first portion and a second portion disposed opposite the first portion. A first restraint is disposed between the first portion and the cover. The first restraint comprises a first restraint body that forms a first restraint channel and a first set of restraint channel ribs to resist repulsive forces generated by the electromagnet degaussing coil. A second restraint is disposed between the second portion and the cover. The second restraint comprises a second restraint body that forms a second restraint channel and a second set of restraint channel ribs to resist repulsive forces generated by the electromagnet degaussing coil. A fan mounted in fluid communication with the restraint channels for cooling the electromagnet degaussing coil.

In some aspects, a method for cooling electromagnet degaussing coils comprises enclosing an electromagnet degaussing coil within an internal cavity of a cover. The method further includes positioning a first restraint and a second restraint in the internal cavity of the cover. The first restraint comprises a first restraint body with a first set of restraint ribs extending therefrom. The first restraint is positioned between the cover and a first portion of the electromagnet degaussing coil such that the first restraint body is spaced from the first portion to form a first restraint channel with the first set of restraint ribs extending through the first restraint channel to resist repulsive forces generated by the electromagnet degaussing coil. The second restraint comprises a second restraint body with a second set of restraint ribs extending therefrom. The second restraint is positioned between the cover and a second portion of the electromagnet degaussing coil such that the second restraint body is spaced from the second portion to form a second restraint channel with the second set of restraint ribs extending through the second restraint channel to resist repulsive forces generated by the electromagnet degaussing coil. The method further includes supplying a cooling fluid to the first restraint channel and the second restraint channel via a fan to cool the electromagnet degaussing coil.

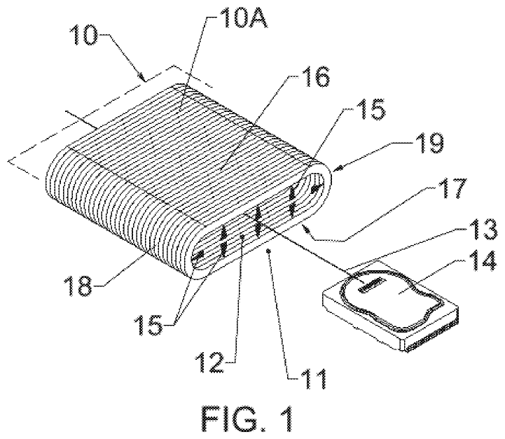

Turning to the figures and, in particular, to FIG. 1 an electromagnet degaussing coil 10 is shown. The electromagnet degaussing coil 10 includes a wound wire 10A in coil form. The wound wire 10A has inner surfaces 12 which are disposed on an inner side of the wound wire 10A. The inner surfaces 12 face inward and are enclosed by the wound wire 10A. The wound wire 10A also has outer surfaces 11 which are disposed on an outer side of the wound wire 10A. The outer surfaces 11 face outward. The electromagnet degaussing coil 10 defines a central axis 13. As illustrated, electromagnet degaussing coil 10 is elliptical shaped when viewed perpendicular to eh central axis 13. The electromagnet degaussing coil 10 has a first flat portion 16 (e.g., a top wire portion) and a second flat portion 17 (e.g., a bottom wire portion) spaced from and opposite the first flat portion 16. The degaussing coil 10 also has a first arched portion 18 on one end and a second arched portion 19 spaced from and opposite the first arched portion 18. The first arched portion 18 and the second arched portion 19 are coupled to the first flat portion 16 and the second flat portion 17. A media 14 is shown adjacent to the electromagnet degaussing coil 10. In some embodiments, the media 14 is a magnetic storage media.

The electromagnet degaussing coil 10 generally includes a system of support material (not shown in FIG. 1) on the inner surfaces 12 of the wound wire 10A as well as on the outer surfaces 11 of the wound wire 10A. In some embodiments, the electromagnet degaussing coil 10 conforms closely to the shape and size of the media 14 that is being erased. The electromagnet degaussing coil 10 generally provides sufficient volume along the central axis 13 to pass the media 14 into and out of the wound wire 10A.

In operation, electrical energy is applied to the electromagnet degaussing coil 10 sufficient to produce a magnetic field strength to erase the media 14. Typically, the electrical energy applied to the electromagnet degaussing coil 10 results in high levels of heating in the wound wires. It is also known by those skilled in the art that high electrical energy levels also result in magnetic flux fields that develop repulsion forces 15 in the wound wire 10A. The repulsion forces 15 which push outward from the central axis 13. The magnitude of repulsion force 15 varies with respect to the distance from central axis 13 and the geometry of electromagnet degaussing coil 10.

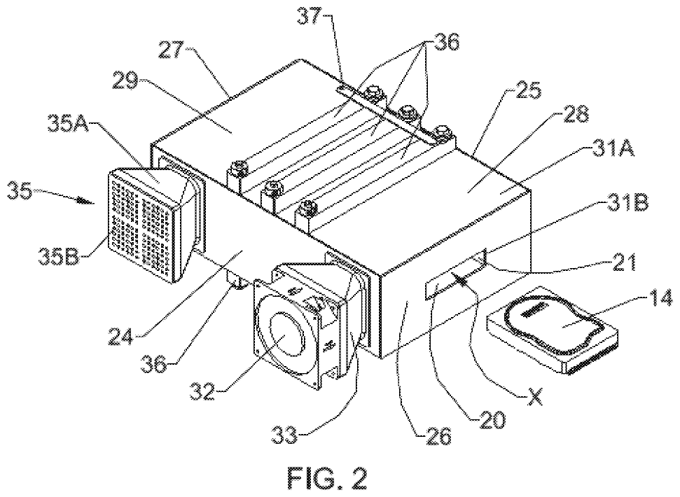

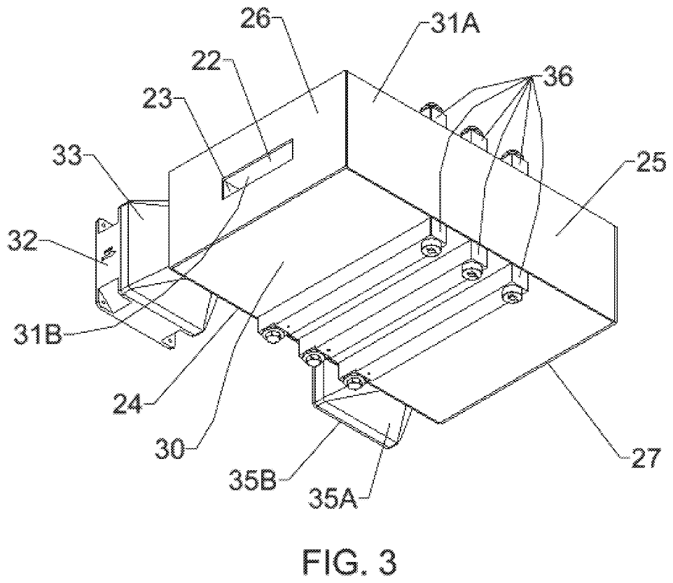

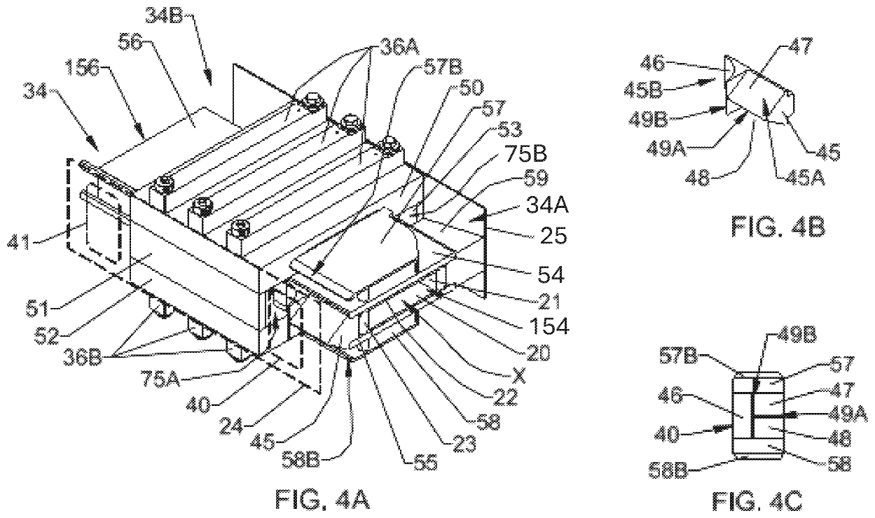

With reference to FIG. 2 and FIG. 3, the electromagnet degaussing coil 10 (not visible in FIGS. 2 and 3) is fully enclosed in a housing or cover 28. The cover 28 includes an outer casing 31A and an inner casing 31B. The outer casing 31A is coupled to and spaced from the inner casing 31B to define an internal cavity 34 of the cover 28 therebetween. The internal cavity 34 of the cover 28 is not shown in FIGS. 2 and 3 but is illustrated in FIG. 4A.

The inner casing 31B of the cover 28 defines a media conveyance path X for receiving the media 14 through the electromagnet degaussing coil 10. As illustrated, the inner casing 31B of the cover 28 includes a bottom wall 20, a top wall 22, a first side wall 21, and a second side wall 23. The media conveyance path X is formed or bounded by the bottom wall 20, the top wall 22, the first side wall 21, and the second side wall 23. The media conveyance path X passes along the central axis 13 of the electromagnet degaussing coil 10. The media conveyance path X allows the media 14 to pass into and out of the electromagnet degaussing coil 10. In some configurations, at least a portion of the electromagnet degaussing coil 10 is disposed around the media conveyance path X.

The outer casing 31A of the cover 28 includes a first end panel 26 and a second end panel 27 that is spaced from and opposite the first end panel 26. The cover 28 further includes a first side panel 24, a second side panel 25, a third side panel 29, and a fourth side panel 30. The first panel 24, the second panel 25, the third side panel 29, and the fourth side panel 30 are disposed between and coupled to the first end panel 26 and the second end panel 27. In some configurations, the third side panel 29 is a top panel of the cover 28 and the fourth panel 30 is a bottom panel of the cover 28. In some embodiments, including the illustrated embodiment, the electromagnet degaussing coil 10 is fully enclosed inside of the structure formed by the first end panel 26, the second end panel 27, the first side panel 24, the second side panel 25, the third side panel 29, and the fourth side panel 30.

A fan 32 and an exhaust assembly 35 are mounted in fluid communication with the internal cavity 34 of the cover 28. In some arrangements, the fan 32 and/or the exhaust assembly 35 are coupled to the cover 28. The fan 32 and/or the exhaust assembly 35 may be coupled to the outer casing 31A. In some configurations, the fan 32 and the exhaust assembly 35 are coupled to the first side panel 24.

The fan 32 of this embodiment is a motorized impeller. In some implementations, the fan 32 can develop a fluid flow of between about 50 CFM and about 400 CFM, between about 100 CFM and about 200 CFM, or, in some aspects, about 130 CFM at a static pressure of 0.5 inches H₂O. The fan 32 can be of this or other fluid flow moving constructions with the capability of developing fluid flow rates above 100 CFM at elevated static pressures above 0.4 inches H₂O

The exhaust assembly 35 includes an exhaust adapter 35A with an exhaust screen 35B. The fan 32 is coupled to the cover 28 via an inlet adapter 33. The cover 28 forms an external structure that restricts air flow from the fan 32 to the proximity over the outer surfaces 11 of the electromagnet degaussing coil 10. Cool air flow from the fan 32 passes through the inlet adapter 33, through an opening on the first side panel 24, and across the outer surfaces 11 of electromagnet degaussing coil 10. The air flow from the fan 32 exhausts out of the cover 28 through the exhaust assembly 35. The media conveyance path X forms an internal structure that constrains the path of air flow coming from the fan 32 to pass over the outer surfaces 11 of the electromagnet degaussing coil 10.

In some embodiments, air conditioned below ambient temperature can be fed into the fan 32 by adding an additional air conditioning unit, such as a thermoelectric cooler or compressor air conditioner (not shown in FIGS. 2 and 3). By circulating air chilled by the air conditioner into the fan 32, out of the exhaust assembly 35, and back into the air conditioning unit, a lack of ambient air introduction into the loop may improve the efficiency of heat removal.

One or more pairs of support bars 36A, 36B are coupled to an outer surface of the cover 28. The support bars 36A, 36B provide sufficient restraint for the repulsion forces 15 developed by the magnet fields of the electromagnet. The quantity, size, and location of the support bars 36A, 36B may vary depending on the magnitude of the magnetic field strength being produced by the electromagnet degaussing coil 10. In some embodiments, the support bars 36A, 36B are made from a non-magnetic and non-sparking type of material. Even when using such a material, eddy currents may be developed in the materials and thus the materials include a grounding source. The ground bar 37 (see FIG. 2) provides a common ground path source connection for the support bars 36A, 36B.

FIGS. 4A and 4B illustrate the bases of the air flow splitting and direction diverting mechanism within an internal cavity 34 of the cover 28. In FIG. 4, all portions of the cover 28, except the first side panel 24 and the second side panel 25, are hidden to reveal the contents within the cover 28. The perimeter of the first side panel 24 is shown in dashed line to denote the location of the first side panel 24 while revealing components present behind the first side panel 24. The first side panel 24 includes a first opening 40 and a second opening 41. The fan 32 (not shown in FIGS. 4A and 4B) is coupled to first side panel 24 adjacent to the first opening 40. The exhaust assembly 35 (not shown in FIGS. 4A and 4B) is coupled to the first side panel 24 adjacent to the second opening 41. The internal cavity 34 of the cover 28 includes fan plenum 34A and an exhaust plenum 34B. The fan plenum 34A is in fluid communication with the fan 32 and the first opening 40 of the first side panel 24. The exhaust plenum 34B in fluid communication with the exhaust assembly 35 and the second opening 41 of the first side panel 24. In some embodiments, such as the illustrated embodiment, the fan plenum 34A is disposed adjacent to an inlet port 154 of the media conveyance path X and the exhaust plenum 34B is disposed adjacent to an exit port 156 of the media conveyance path X.

The fan plenum 34A includes an inlet diverter 45, a top diverter 57, a bottom diverter 58, and a side diverter 59 are disposed therein. The fan plenum 34A of the internal cavity 34 also includes a first support plate 54 and a second support plate 55. The inlet diverter 45, the top diverter 57, and the side diverter 59 are coupled to and supported by the first support plate 54 and the second support plate 55. The internal cavity 34 of the cover 28 further includes a first side support block 51, a second side support block 53, a top support block 50, and a bottom support block 52. Together, the side support block 51, the top support block 50, the bottom support block 52, and the first arched portion 18 of the electromagnet degaussing coil 10 (not shown in FIGS. 4A and 4B but see FIG. 1) form a first channel 75A. Together, the second side support block 53, the top support block 50, the bottom support block 52, and the second arched portion 19 of the electromagnet degaussing coil 10 (not shown in FIGS. 4A and 4B but see FIG. 1) form a second channel 75B. The first channel 75A and the second channel 75B are disposed between the fan plenum 34A and the exhaust plenum 34B.

In the illustrated embodiment, the inlet diverter 45, the top diverter 57 and the bottom diverter 58 are disposed in the fan plenum 34A. Though, it is contemplated that one or more of these diverters may not be included. For example, in some embodiments, the fan plenum 34A may include only the inlet diverter 45. Further, the shape and position of the diverters may differ from the shapes illustrated and may depend on the shape of the electromagnet degaussing coil 10.

The inlet diverter 45 is positioned adjacent to and, in some aspects, is aligned with the first opening 40 in the first side panel 24 such that air flow entering the first opening 40 encounters the inlet diverter 45. The inlet diverter 45 (see FIG. 4B) includes an edged body 45A coupled to an arcuate body 45B. The edged body 45A includes a first incline surface 47 and a second incline surface 48. The first incline surface 47 is for directing fluid flow from the fan 32 to a first portion (e.g., the first flat portion 16) of the electromagnet degaussing coil 10. The second incline surface 48 is for directing fluid flow from the fan 32 to a second portion (e.g., the second flat portion 17) of the electromagnet degaussing coil 10. The first incline surface 47 is coupled to the first support plate 54. The second incline surface 48 is coupled to the second support plate 55. The first incline surface 47 joins the first incline surface 48 to form an edge of the edged body 45A that faces the first side panel 24. In some configurations, the edge is aligned with the first opening 40 of the first side panel 24. The first incline surface 47 is disposed at an angle relative to the second incline surface 48. In some configurations, the edged body 45A generally shaped as a triangular prism, with the first incline surface 47 and the second incline surface 48 forming faces or lateral sides of the triangular prism. The arcuate body 45B includes a curved surface 46. The curved surface 46 of the arcuate body is for directing fluid flow from the fan 32 to a third portion (e.g., the first arched portion 18) of the electromagnet degaussing coil 10. In some configurations, the curved surface 46 is for directing fluid flow from the fan 32 through the first channel 75A that is disposed adjacent to the first arched portion 18 of the electromagnet degaussing coil. The arcuate body 45B of the inlet diverter 45 may be disposed at an inlet of the first channel 75A. In some configurations, the curved surface 46 of the arcuate body 45B faces the first side panel 24.

The top diverter 57 is coupled to the first support plate 54. Though, the top diverter 57 may be supported in any suitable manner. The top diverter 57 includes an incline surface 57B. The incline surface 57B faces the first side wall 24 of the cover 28. In some configurations, the incline surface 57B of the top diverter 57 faces the fan 32. In some configurations, the incline surface 57B is aligned with the first incline surface 47 of the inlet diverter 45, for example, the incline surface 57B is disposed directly above the first incline surface 47. In some embodiments, the top diverter 57 is a generally planar panel. The planar panel may be disposed parallel to the third side panel 29 (not shown in FIGS. 4A and 4B) of the cover 28. In some configurations, at least a portion of the top diverter 57 is disposed above the inlet diverter 45. In some cases, the top diverter 57 may not be required to achieve suitable air flow diversion.

The bottom diverter 58 is coupled to the second support plate 55. Though, the bottom diverter 58 may be supported in any suitable manner. The bottom diverter 58 includes an incline surface 58B. The incline surface 58B faces the first side wall 24 of the cover 28. In some configurations, the incline surface 58B of the bottom diverter 58 faces the fan 32. In some configurations, the incline surface 58B is aligned with the first incline surface 47 of the inlet diverter 45, for example, the incline surface 58B is disposed directly below the first incline surface 47. In some embodiments, the bottom diverter 58 is a generally planar panel. The planar panel is disposed parallel to the fourth side panel 30 (not shown in FIGS. 4A and 4B) of the cover 28. In some configurations, at least a portion of the bottom diverter 58 is disposed below the inlet diverter 45.

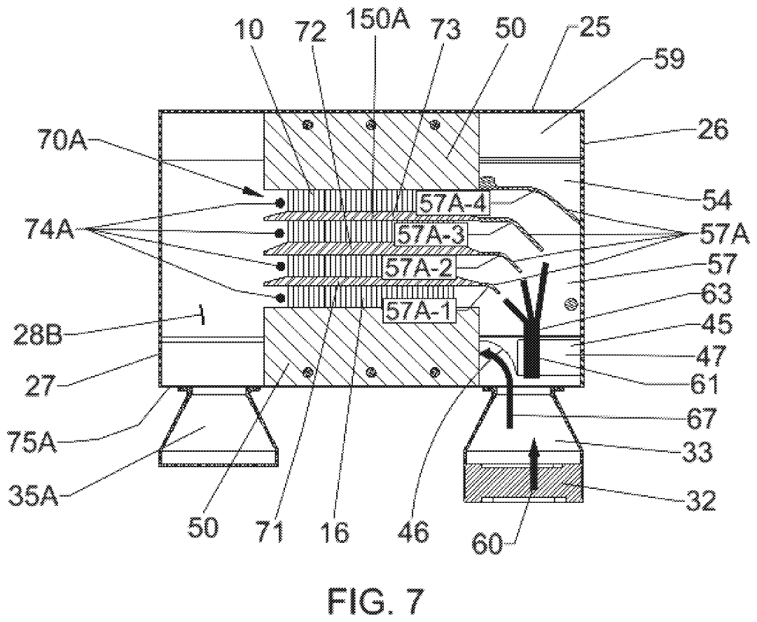

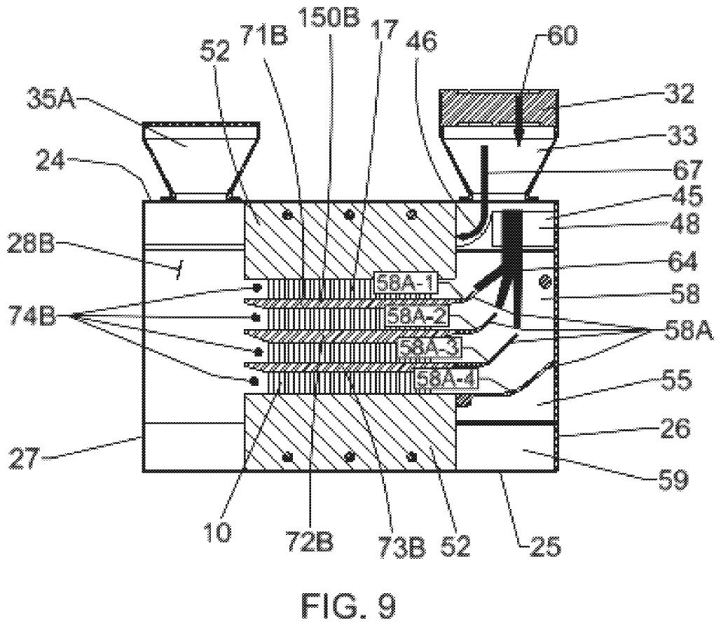

In some embodiments, the bottom diverter 58 and the top diverter (not shown in FIG. 9 but see FIG. 7) may have an identical or nearly identical geometry to maintaining symmetric and uniform cooling over differing regions of the electromagnet degaussing coil 10. In some embodiments, the configuration of the electromagnet degaussing coil 10 may involve differing geometries for the bottom diverter 58 and the top diverter 57 to achieve desirable cooling performance.

The side diverter 59 is disposed adjacent to the second side panel 25 of the cover 28. The side diverter 59 is disposed at an inlet of the second channel 75B. The side diverter 59 is coupled to the second side panel 25 of the cover 28. The side diverter 59 is also coupled to the first support plate 54.

In operation, air flow from the fan 32 passes through the first opening 40. The air flow from the fan 32 encounters the inlet diverter 45. The inlet diverter 45 is a multi-directional air flow splitter and direction changing device. The exact geometry of the inlet diverter 45 may depend on the percentage of air flow required to pass over the outer surfaces 11 of the first flat portion 16, the second flat portion 17, the first arched portion 18, and the second arched portion 19 of the electromagnet degaussing coil 10. Uniform cooling of an electromagnet coil may involve uniform but differing amounts of air flow in different regions. A portion of the incoming air flow that encounters the inlet diverter 45 strikes the curved surface 46 of the inlet diverter 45 and becomes redirected along the outside surface of the wound wire 10A. The air flow coming from the curved surface 46 passes through the first channel 75A. After this air flow passes over the entire length of the electromagnet degaussing coil 10 (see FIG. 1), it enters the exhaust plenum 34B located on the opposite end of the electromagnet degaussing coil 10 from where it entered. The warm air in the exhaust plenum 34B is allowed to pass through the second opening 41 in the first side panel 24 and is released back into the ambient environment.

A remainder of the cool air flow that passes through first opening 40 and strikes inlet diverter 45 that was not redirected by the curved surface 46 is divided into two equal portions by the first incline surface 47 and the second incline surface 48. Air flow that passes over the first incline surface 47 is diverted upward and toward the top diverter 57. The air flow portion that was directed upward by the first incline surface 47 is again divided into two nonequal portions by the upper cover surface of top diverter 57. The portion of air flow that passes between the upper cover surface of the top diverter 57 and the first support plate 54 is directed and passes over the outside surface of the first flat portion 16 of the electromagnet degaussing coil 10. Heat is removed from the electromagnet wires as this cool air passes over them and moves into the exhaust plenum 34B. The remaining air flow portion coming from the first incline surface 47 that was not diverted beneath the upper cover surface of the top diverter 57, and directed along the first flat portion 16, passes above the upper cover surface of the top diverter 57 and below the cover 28 (see FIG. 2). The air flow that passes between the top diverter 57 and the cover 28 (see FIG. 2) continues along a path in the direction of the second side panel 25. The cool air flow that encounters the second side panel 25 is directed downward toward the side diverter 59. The side diverter 59 further redirects the air flow direction along the second channel 75B. After this air flow passes over the entire length of the electromagnet degaussing coil 10, it enters the common exhaust plenum 34B located on the opposite end of the electromagnet degaussing coil 10 from where it entered. The warm air in the exhaust plenum 34B is allowed to pass through the second opening 41 of first side panel 24 and is released back into the surrounding environment.

The inclined surface 48 of the inlet diverter 45 redirects the remainder of incoming cool air flow not encountering the curved surface 46 and the first incline surface 47 downward toward the bottom diverter 58. The air flow portion that was directed downward by the incline surface 48 is further divided into two nonequal portions by the cover surface of the bottom diverter 58. The portion of air flow that passes between the cover surface of the bottom diverter 58 and the second support plate 55 is redirected and passes over the outside surface of the second flat portion 17 of the electromagnet degaussing coil 10 (see FIG. 1). Heat is removed from the electromagnet degaussing coil 10 as this cool air passes over them and moves into the exhaust plenum 34B. The remaining air flow portion coming from incline surface 48 is directed along the second flat portion 17 of the electromagnet degaussing coil 10 of FIG. 1, passes between the cover surface of the bottom diverter 58, and the fourth side panel 30 (see FIG. 3). Air flow that passes between the bottom diverter 58 and the fourth side panel 30 (see FIG. 3) continues along a path in the direction of second side panel 25. The cool air flow that encounters second side panel 25 is directed upward toward the side diverter 59. The side diverter 59 further redirects the air flow direction along the second channel 75B. After this air flow passes over the entire length of the electromagnet degaussing coil 10, the air flow enters the exhaust plenum 34B located on the opposite end of the electromagnet degaussing coil 10 from where it entered. The warm air in the exhaust plenum 34B is allowed to pass through the second opening 41 of the first side panel 24 and is released back into the surrounding environment.

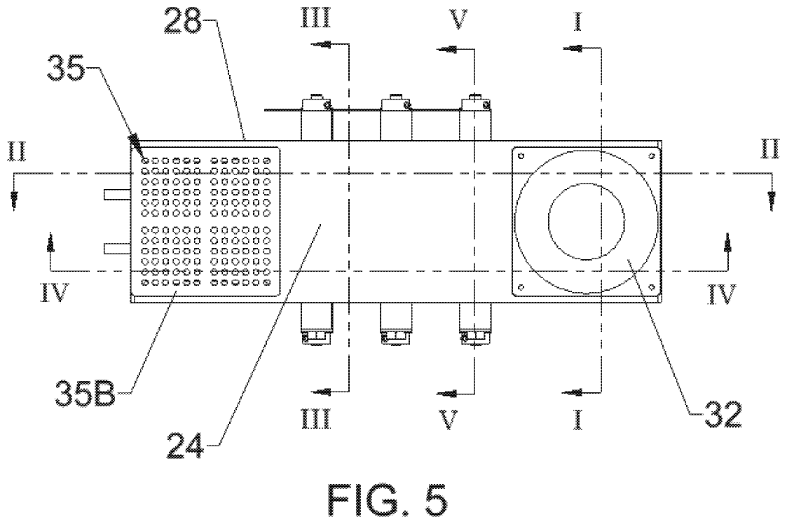

FIG. 5 shows the first side panel 24 of the cover 28. The first side panel 24 includes the fan 32 and the exhaust screen 35B of the exhaust assembly 35. The fan 32 is operable to force cool air into the internal cavity 34 of the cover 28 to push this same air over the outer surfaces 11 of the electromagnet degaussing coil 10 (not visible in FIG. 5 but see FIG. 1). The exhaust screen 35B allows the air flow that has been heated after passing over the electromagnet wires to return to a cooler surrounding environment.

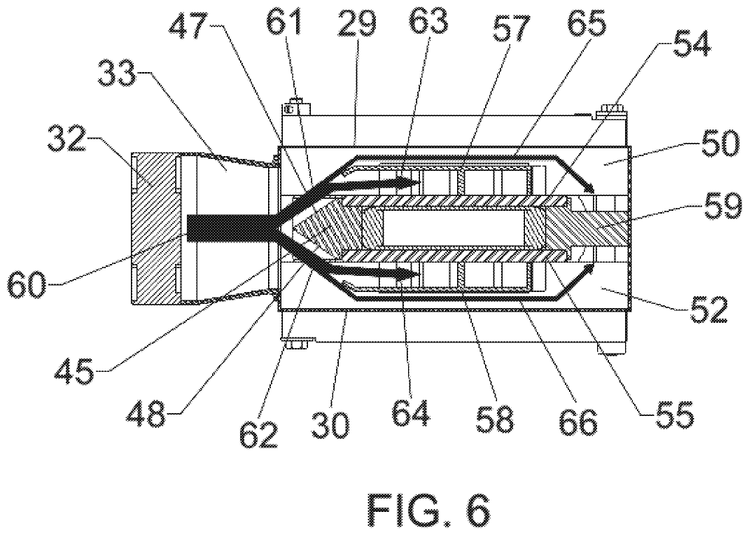

FIG. 6 shows a section view taken along line “I-I” of FIG. 5. FIG. 6 depicts the splitting and diverting of cool air flow by the inlet diverter 45, the top diverter 57, and the bottom diverter 58 to uniformly cool the electromagnet degaussing coil 10. As shown, the air flow is cooling the outer surfaces 11 of the electromagnet degaussing coil 10. Due to the positioning of the section line “I-I”, the electromagnet degaussing coil 10 is not visible in FIG. 6. The flow of air as illustrated cools the outer surfaces 11 of the first flat portion 16, the second flat portion 17, and the second arched portion 19 of the electromagnet degaussing coil 10.

The fan 32 pushes ambient air into the internal cavity 34 of the cover 28 to create an inlet air flow 60. The inlet air flow 60 enters the cover 28 through the inlet adapter 33. Upon entering the internal cavity 34 of the cover 28, the inlet air flow 60 contacts the inlet diverter 45. The first incline surface 47 of the inlet diverter 45 creates a top air flow portion 61 that moves towards top diverter 57 and a bottom air flow portion 62 that moves toward the bottom diverter 58. The top diverter 57 splits the top air flow portion 61 into a first top air flow portion 63 and a second top air flow portion 65. The first top air flow portion 63 flows between a surface of the top diverter 57 and the first support plate 54. The second top air flow portion 65 passes through the gap formed between top diverter 57 and the cover 28. The incline surface 48 creates air flow that moves towards the bottom diverter 58 where it is split into a first bottom air flow portion 64, that flows between dividing cover surface of bottom diverter 58 and the second support plate 55. The second incline surface 48 of the inlet diverter 45 creates the first bottom air flow portion 64 and a second bottom air flow portion 66. The first bottom air flow portion 64 passes through a gap formed between the bottom diverter 58 and the fourth side panel 30 of the cover 28. The second top air flow portion 65 and the second bottom air flow portion 66 move toward the side diverter 59. The side diverter 59 further redirects the second top air flow portion 65 and the second bottom air flow portion 66 toward the second channel 75B. The second channel 75B provides a cool air stream over the second arched portion 19 of the electromagnet degaussing coil 10 (not visible in FIG. 6 but see FIG. 1).

It is contemplated that the inlet diverter 45 may be shaped to divide the inlet air flow 60 in a particular manner. For example, the inlet diverter 45 may be shaped to direct particular quantities of the inlet air flow 60 upward by the first incline surface 47, downward by the second incline surface 48, and toward the first channel 75A by the curved surface 46. In some embodiments, about 40 percent of the inlet air flow 60 is redirected upward by incline surface 47, about 40 percent of the inlet air flow 60 is redirected downward by incline surface 48, and about 20 percent of the inlet air flow 60 is redirected towards the first channel 75A by the curved surface 46 (not visible in FIG. 6 but see FIGS. 4A and 4B). Though, the inlet air flow 60 may be spilt or divided in any suitable manner to achieve a desired cooling effect for the electromagnet degaussing coil 10. For an electromagnet coil that has a different geometry (e.g., flat portions 16, 17 longer or shorter, arched portions 18, 19 with different radius, etc.) than the electromagnet coil 10 described herein, there may be different percentage splits for the airflow passing over the inlet diverter 45. For example, the inlet diverter 45 may have unequal rib supports for the flat portions 16, 17.

Turning briefly to FIG. 4C, the rectangular first opening 40 in relation to inlet diverter 45 and the corresponding surfaces is shown. The area of curved surface 46, as seen through first opening 40, of this invention is 20% of the total rectangular area of first opening 40. The area of curved surface 46, seen through first opening 40, can be adjusted by means of changing the length of diverter edge 49A that results in a position change of curved surface edge 49B. It is also possible to change the length of curved surface edge 49B without changing the length of diverter edge 49A. The remaining portion of air flow not encountering curved surface 46 will be divided by diverter edge 49A into portions as determined by the location in first opening 40. Generally, the position of diverter edge 49A will be centered, vertically, in first opening 40 to provide equal portions to top and bottom regions. The portion of fluid flow to top and bottom regions can be changed be moving the position of diverter edge 49A up or down relative to first opening 40. It is also realized that changing the geometry of first opening 40 or a combination of this and the changes described to diverter edge 49A and curved surface edge 49B can achieve desired regulation of air flow to a prescribed region.

FIG. 7 is a top section view taken along line “II-II” in FIG. 5. FIG. 7 shows air flow paths over the first flat portion 16 of the electromagnet degaussing coil 10. The inlet air flow 60 from the fan 32 passes through the inlet adapter 33. The inlet air flow 60 encounters and is diverted by the inlet diverter 45 and the top diverter 57. The inlet air flow 60 encounters a first brace or restraint 150A disposed between the first flat portion 16 of the electromagnet degaussing coil 10 and the cover 28 (not shown in FIG. 7).

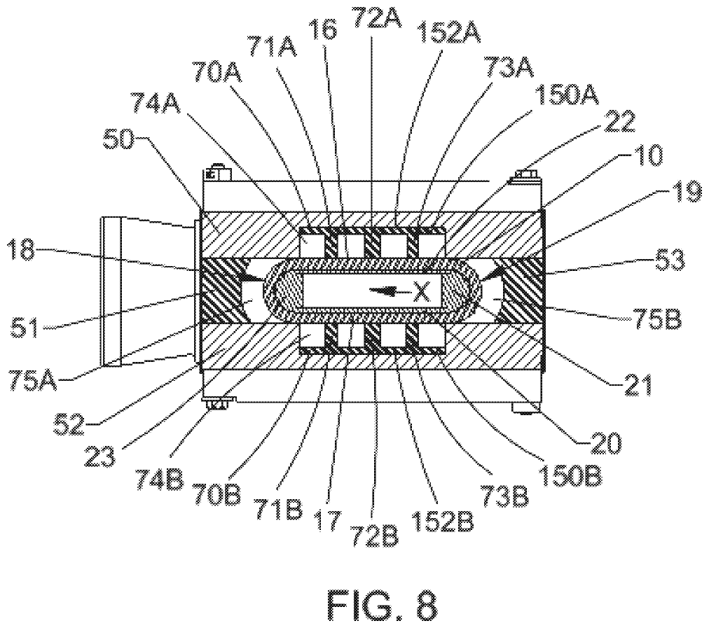

The first restraint 150A includes a first restraint body 152A (not shown in FIG. 7 but see FIG. 8). A first restraint channel rib 71A, a second restraint channel rib 72A, and a third restraint channel rib 73A are coupled to the first restraint body 152A. The first set of restraint channel ribs 71A, 72A, 73A may resist repulsive forces generated by the electromagnet degaussing coil 10. The first restraint 150A forms a first restraint channel 70A for receiving and directing air flow across the flat portion 16 of the electromagnet degaussing coil 10. The first restraint channel 70A is in fluid communication with the fan plenum 34A and the exhaust plenum 34B of the internal cavity 34 of the cover 28. The first set restraint channel ribs 71A, 72A, 73A extend through the first restraint channel 70A from the fan plenum 34A to the exhaust plenum 34B. The first restraint channel 70A through which the first set of restraint channel ribs 71A, 72A, 73A extend is illustrated in further detail in FIG. 8. The first set of restraint channel ribs 71A, 72A, 73A divide the first restraint channel 70A into a plurality of top air passages 74A. The plurality of top air passages 74A may be of differing widths, for example, to optimize cooling for electromagnet configurations that are of a different shape or size from the illustrated embodiment. In some embodiments, at least a portion of the inside surfaces of the electromagnet degaussing coil 10 are in direct contact with the inner casing 31B of the cover 28. Further, in some embodiments, at least a portion out the outside surfaces of the electromagnet degaussing coil 10 are in direct contact with the first restraint 150A. As configured, the restraint 150A may act as both a heatsink and a restraint or support to resist forces generated in the electromagnet degaussing coil 10.

The top diverter 57 includes one or more fins 57A. In the illustrated embodiment, the fins 57A include a first fin 57A-1, a second fin 57A-2, a third fin 57A-3, and a fourth fin 57A-4. The first fin 57A-1 is coupled to the first restraint channel rib 71A. The second fin 57A-2 is coupled to the second restraint channel rib 72A. The third fin 57A-3 is coupled to the third restraint channel rib 73A. The fourth fin 57A-4 is coupled to the top support block 50.

In some embodiments, one or more of the fin(s) 57A are be disposed at different angles relative to the first side panel 24. As illustrated, the fin(s) 57A are of differing lengths though, in some embodiments, one or more of the fin(s) 57A may be the same length. Depending on the electromagnet configuration that is to be cooled, the length, the angle properties, and or a quantity of the fin(s) 57A on top diverter 57 may be adjusted to optimize the cooling effect. In some embodiments, the leading edges of the fin(s) 57A on are rounded or curved to reduce air flow resistance. The radius on the inside bend surface of each of the fin(s) 57A may be adjusted help reduce air flow resistance and improve cooling efficiency.

In some embodiments, the leading edges of ribs in the first set of restraint channel ribs 71A, 72A, 73A may be angled and/or rounded at the end to also help reduce air flow losses due to the friction. The tapered angle on the leading edges may provide a means to increase the air flow velocity as it passes over the wires of the electromagnet and results in greater cooling efficiency.

In some embodiments, the top support block 50 and the walls bordering the first restraint channel 70A are made from materials that are of an electrical insulating, nonmagnetic, and/or nonthermally conductive type. Operating performance of electromagnet coil 10 of FIG. 1 will be improved when the top support block 50 and the walls bordering the first restraint channel 70A are made from materials are made of such materials.

A portion 67 of the inlet air flow 60 encounters the curved surface 46 of the inlet diverter 45. The portion 67 of the inlet air flow 60 that strikes the curved surface 46 is diverted along a path over the first arched portion 18 of the electromagnet degaussing coil 10 and exits into the exhaust plenum 34B. The exhaust plenum 34B is bounded by the first side panel 24, the second side panel, the second end panel 27, the third side panel 29, and the fourth side panel 30. The third side panel 29 and the fourth side panel 30 are not visible in FIG. 7 but are shown in FIGS. 2 and 3.

The top air flow portion 61 encounters the first incline surface 47 of the inlet diverter 45. The top air flow portion 61 is directed toward the top diverter 57 to create the first top air flow portion 63. The fin(s) 57A collect and redirect the first top air flow portion 63 toward the first flat portion 16 of the electromagnet degaussing coil 10. In the illustrated embodiment, the fin(s) 57A split the first top air flow portion 63 into four equal streams of air volume. Each of the fin(s) 57A of the top diverter 57 may be angled toward the inlet air flow 60 to increase or maximize cooling efficiency. The first top air flow portion 63 from the top diverter 57 then enters and follows the first channel 75A that is formed by the geometry of top support block 50 and the top air passages 74A that are formed by the first set of restraint channel ribs 71A, 72A, and 73A. The air flow that passes over the first flat portion 16 of the electromagnet degaussing coil 10 extracts heat as it moves along the length of the top air passages 74A. The air flow from the top air passages 74A exits into the exhaust plenum 34B. The warm air volume contained in exhaust plenum 34B is flushed out of the internal cavity 34 of the cover 28 through exhaust adapter 35A as subsequent air moves into the exhaust plenum 34B.

FIG. 8 is a section view taken along line “III-III” in FIG. 5. FIG. 8 further illustrates details of the media conveyance path X, the restraint channels 70A, 70B, the first channel 75A, and he second channel 75B. FIG. 8 also illustrates the position of the electromagnetic degausser wire 10 relative to the media conveyance path X, the restraint channels 70A, 70B, the first channel 75A, and the second channel 75B.

The media conveyance path X is bounded by the bottom wall 20, the top wall 22, the first side wall 21, and the second side wall 23. Generally, the media conveyance path X is centered in the electromagnet degaussing coil 10. The electromagnet degaussing coil 10 is wound around the media conveyance path X.

The first restraint body 152A is spaced from the first flat portion 16 of the electromagnet degaussing coil 10 to define the first restraint channel 70A. The first restraint channel 70A is disposed between first flat portion 16 of the electromagnet degaussing coil 10 and the first restraint body 152A. The first restraint channel 70A is positioned on or adjacent to the first flat portion 16 of the electromagnet degaussing coil 10. The first restraint channel 70A includes the first restraint channel rib 71A, the second restraint channel rib 72A, and the third restraint channel rib 73A. The first set of restraint channel ribs 71A, 72A, 73A is disposed between the top support block 50 and the electromagnet degaussing coil 10. The first set of restraint channel ribs 71A, 72A, 73A creates a space between the top support block 50 and the electromagnet degaussing coil 10 to form the top air passages 74A. The first restraint channel 70A is disposed in a recessed area of the top support block 50. The top support block 50 provides walls for the two outside top air passages 74A. In the current embodiment, the straight wire section of the electromagnet degaussing coil 10 are of equal length. With a symmetrical configuration of the straight wire section there will be equal heating in both the top and bottom regions of the electromagnet degaussing coil 10.

The second restraint body 152B is spaced from the second flat portion 16 of the electromagnet degaussing coil 10 to define the second restraint channel 70B. The second restraint channel 70B is disposed between the second flat portion 17 of the electromagnet degaussing coil 10 and the second restraint body 152B. The second restraint channel 70B is disposed on or adjacent to the second flat portion 17 of the electromagnet degaussing coil 10. The second restraint channel 70B is generally the same as the first restraint channel 70A. The second restraint channel 70B includes the second set of restraint channel ribs 71B, 72B, 73B that is used on is also included on the second flat portion 17. The second set of restraint channel ribs 71B, 72B, 73B creates a space between the bottom support block 52 and the electromagnet degaussing coil 10 to form a plurality of bottom air passages 74B. The second restraint channel 70B is in fluid communication with the fan plenum 34A and the exhaust plenum 34B of the internal cavity 34 of the cover 28. The second set of restraint channel ribs 71B, 72B, 73B extend through the second restraint channel 70B from the fan plenum 34A to the exhaust plenum 34B. The second restraint channel 70B is disposed within a recessed area of the bottom support block 52. The bottom support block 52 provides the walls for the two outside bottom air passages 74B. In some embodiments, a total open air passage area of the bottom air passages 74B is approximately equal to a total open area of the top air passages 74A to provide uniform cooling to both of the flat portions 16, 17.

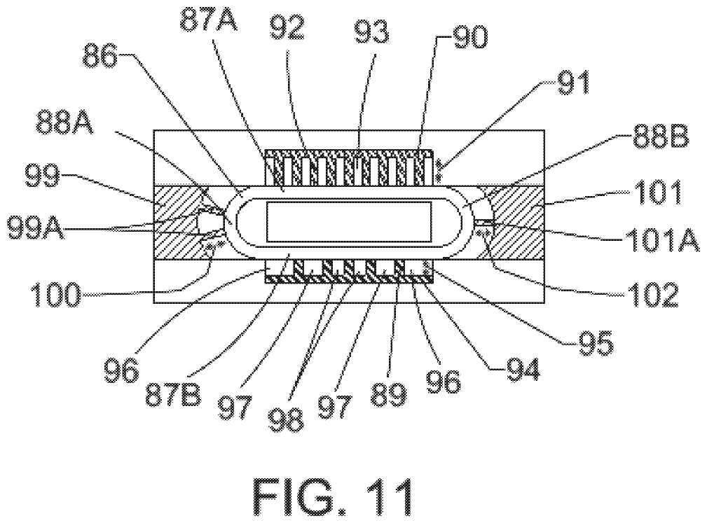

In some embodiments, a number of ribs in the first set of restraint channel ribs 71A, 72A, 73A is the same as a number of ribs in the second set of restraint channel ribs 71B, 72B, 73B. In other embodiments (see FIG. 11), the number of ribs in the first set of restraint channel ribs 71A, 72A, 73A is the different from the number of ribs in the second set of restraint channel ribs 71B, 72B, 73B.

The first arched portion 18 of electromagnet degaussing coil 10 is cooled by air flow that moves through the first channel 75A that is formed by top support block 50, the first side support block 51, and the bottom support block 52. Likewise, the second arched portion 19 of electromagnet wire form 10 is cooled by air flow that moves through the second channel 75B that is formed by the top support block 50, the second side support block 53, and the bottom support block 52. Being of symmetrical configuration, the area of the first channel 75A that supplies cool air flow to the first arched portion 18 is equal to the area of the second channel 75B that supplies cool air flow to the second arched portion 19.

In some embodiments, such as the illustrated embodiment, the electromagnet degaussing coil 10 is comprised of two flat portions 16, 17 (see also FIG. 1) and two arched portions 18, 19 (see also FIG. 1). In some embodiments, a length of the first flat portion 16 comprises about 30 percent of a total length of the of the electromagnet degaussing coil 10. In some embodiments, the electromagnet degaussing coil 10 is of symmetrical form such that a length of the second flat portion 17 comprises about 30 percent of a total length of the of the electromagnet degaussing coil 10. In some embodiments, a length of the arched portions 18, 19 comprise about 20 percent of a total length of the of the electromagnet degaussing coil 10.

The first set of restraint channel ribs 71A, 72A, 73A of the first restraint channel 70A, the second set of restraint channel ribs 71B, 72B, 73B of the second restraint channel 70B, portions of top support block 50, and portions of the bottom support block 52 cover portions of the external surface of electromagnet degaussing coil 10. In some embodiments, a total exposed wire length is comprised of a total wire length minus any material from the first restraint channel 70A, the second restraint channel 70B, the portions of top support block 50, and the portions of the bottom support block 52 that contact the electromagnet degaussing coil 10 and eliminates direct air flow to the wires.

In some embodiments, the exposed wire length of the flat portions 16, 17 and the arched portions 18, 19 may have the same length percentages as mentioned before, for example, to achieve symmetrical and uniform cooling. Though, it is possible to use a geometry that results in different percentages of exposed versus a combined exposed and unexposed length. Further, in some embodiments, a sum of a cross-sectional area of the top air passages 74A, a cross-sectional area of the bottom air passages 74B, a cross-sectional area of the first channel 75A, and a cross-sectional area of the second channel 75B comprises a total cross-sectional area of air flow over the wires of electromagnet coil 10. Further, in some embodiments, the cross-sectional areas in these same four regions may also closely follow the same mentioned percentages. Electromagnet configurations that are different from the current embodiment may involve different percentages or differing portions between the exposed wire length and the cross-sectional area.

In some embodiments, a distance between the first restraint channel rib 71A and the second restraint channel rib 72A is about 7.5 percent of the required total exposed wire length. In some embodiments, a width of each air top passage 74A is about 7.5 percent of the total exposed wire. In some embodiments, an exposed length of each of the arched portions 18, 19 (see also FIG. 1) is about 20 percent of a total exposed wire length for the electromagnet degaussing coil 10. The cooling efficiency near the ends of the arched portions 18, 19 may decrease and result in an effective cooling over about 90 percent of the full arc length.

In some embodiments, a cross-sectional air of the top air passage 74A in between the first restraint channel rib 71A and the second restraint channel rib 72A is approximately equal to a distance between these same two ribs multiplied by a rib height. In some embodiments, a cross-sectional area of each of the top air passages 74A comprises about 7.5 percent of a total cross-sectional air flow path area.

In some embodiments, each of the first channel 75A and the second channel 75B comprises about 20 percent of a total cross-sectional air flow path area. The distance between the outside surface of electromagnet degaussing coil 10 and the first side support block 51 and the distance between the outside surface of electromagnet degaussing coil 10 and the second side support block 53 may be sized to achieve the 20 percent cross-sectional area for each channel 75A, 75B, respectively.

FIG. 9 depicts a bottom section view taken along line “IV-IV” of FIG. 5. FIG. 9 shows the air flow path over the second flat portion 17 of the electromagnet degaussing coil 10. The inlet air flow 60 from the fan 32 passes through the inlet adapter 33. The inlet air flow 60 encounters and is diverted by the inlet diverter 45 and the bottom diverter 58. The inlet air flow 60 encounters a second brace or restraint 150B disposed between the second flat portion 17 of the electromagnet degaussing coil 10 and the cover 28 (not shown in FIG. 9).

The second restraint 150B includes a second restraint body 152B (not shown in FIG. 9 but see FIG. 8). The second restraint channel rib 71B, the second restraint channel rib 72B, and the third restraint channel rib 73B are coupled to the second restraint body 152B. The second set of restraint channel ribs 71B, 72B, 73B may resist repulsive forces generated by the electromagnet degaussing coil 10. The second restraint 150B forms the second restraint channel 70B for receiving and directing air flow across the flat portion 17 of the electromagnet degaussing coil 10. The second set of restraint channel ribs 71B, 72B, 73B extend through the second restraint channel 70B. The second restraint channel 70B through which the second set of restraint channel ribs 71B, 72B, 73B extend is illustrated in further detail in FIG. 8. The second set of restraint channel ribs 71B, 72B, 73B divide the second restraint channel 70B into a plurality of the bottom air passages 74B. The plurality of the bottom air passages 74B may be of differing widths, for example, to optimize cooling for electromagnet configurations that are of a different shape or size from the illustrated embodiment. In some embodiments, at least a portion of the inside surfaces of the electromagnet degaussing coil 10 are in direct contact with the inner casing 31B of the cover 28. Further, in some embodiments, at least a portion out the outside surfaces of the electromagnet degaussing coil 10 are in direct contact with the second restraint 150B. As configured, the restraint 150B may act as both a heatsink and a restraint or support to resist forces generated in the electromagnet degaussing coil 10.

The bottom diverter 58 includes one or more fins 58A. In the illustrated embodiment, the fins 58A include a first fin 58A-1, a second fin 58A-2, a third fin 58A-3, and a fourth fin 58A-4. The first fin 58A-1 is coupled to the first restraint channel rib 71B. The second fin 58A-2 is coupled to the second restraint channel rib 72B. The third fin 58A-3 is coupled to the third restraint channel rib 73B. The fourth fin 58A-4 is coupled to the bottom support block 52.

In some embodiments, one or more of the fin(s) 58A are disposed at different angles relative to the first side panel 24. As illustrated, the fin(s) 58A are of differing lengths though, in some embodiments, one or more of the fin(s) 58A may be the same length. Depending on the electromagnet configuration that is to be cooled, the length, the angle properties, and or a quantity of the fin(s) 58A on the bottom diverter 58 may be adjusted to optimize the cooling effect. In some embodiments, the leading edges of the fin(s) 58A on are rounded or curved to reduce air flow resistance. The radius on the inside bend surface of each of the fin(s) 58A may be adjusted help reduce air flow resistance and improve cooling efficiency.

In some embodiments, the leading edges of the second set of restraint channel ribs 71B, 72B, 73B may be angled and/or rounded at the end to also help reduce air flow losses due to the friction. The tapered angle on the leading edges may provide a means to increase the air flow velocity as it passes over the wires of the electromagnet and results in greater cooling efficiency.

In some embodiments, the bottom support block 52 and/or walls bordering the second restraint channel 70B are made from materials that are electrical insulating, nonmagnetic, and/or nonthermally conductive. Operating performance of electromagnet degaussing coil 10 of FIG. 1 will be improved when the bottom support block 52 and the walls bordering the second restraint channel 70B are made of such materials.

The inlet air flow 60 from the fan 32 passes through inlet adapter 33 and encounters curved surface 46 and inclined surface 48. The portion 67 of the inlet air flow 60 that strikes curved surface 46 is diverted along a path over the first arched portion 18 (not visible in FIG. 9 but see FIG. 1) and exits into the exhaust plenum 34B.

The inlet air flow 60 that encounters the incline surface 48 of the inlet diverter 45 is directed toward bottom diverter 58. The fin(s) 58B of the bottom diverter 58 collect and redirect the first bottom air flow portion 64 (see also FIG. 6) into four equal streams of air volume. The first bottom air flow portion 64 passes over the second flat portion 17. The current embodiment shows bottom diverter 58 with fins that split the first bottom air flow portion 64 into four equal streams of air volume. The first bottom air flow portion 64 from the bottom diverter 58 then enters and follows the second channel 75B that is formed by the geometry of bottom support block 52 and the bottom air passages 74B formed by the second set of restraint channel ribs 71B, 72B, 73B. The air flow that passes over the second flat portion 17 of the electromagnet degaussing coil 10 extracts heat as it moves along the length of the bottom air passages 74B. The air flow from the bottom air passages 74B exits into the exhaust plenum 34B. The warm air volume contained in exhaust plenum 34B is flushed out of the internal cavity 34 of the cover 28 through exhaust adapter 35A as subsequent air moves into the exhaust plenum 34B.

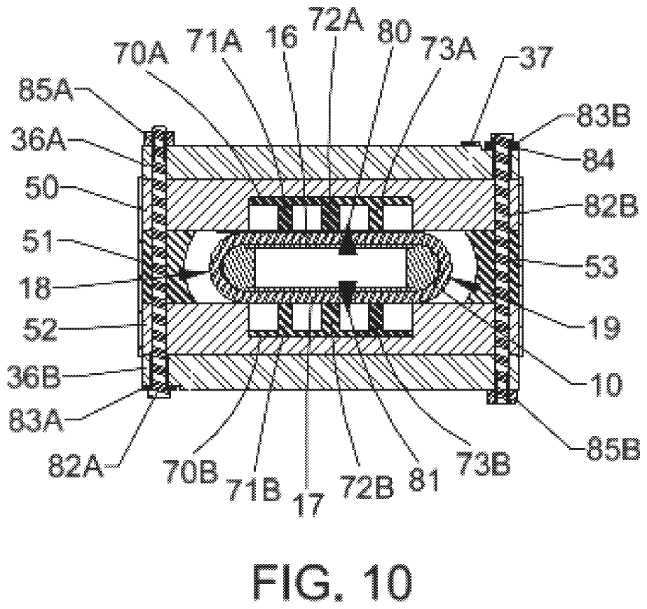

FIG. 10 depicts a section view taken along line “V-V” of FIG. 5. FIG. 5 shows external supports that are used to restrain motion in electromagnet degaussing coil 10. When electrical current is applied to the electromagnet degaussing coil 10 the wires generate a magnetic flux field that results in a repulsive force between the wires of the first flat portion 16 and the wires of the second flat portion 17. This repulsive force moves the wires of the electromagnet degaussing coil 10 outward in the direction of arrows 80 and 81. To maintain the operating characteristics and preserve the life of the electromagnet degaussing coil 10 sufficient external support is provided to restrict outward motion in the magnet wires. Due to the symmetrical aspect of the electromagnet degaussing coil 10, the outward motion and force applied by the wires in the direction of arrows 80 and 81 is equal. Also, the magnitude of magnetic flux at the center of the electromagnet degaussing coil 10 is greater than the magnet flux near the arched portions 18, 19.

The restraint channels 70A, 70B serve as a dual function member. A first function of the restraint channels 70A, 70B is to provide air passage channels for the cooling of the outside surface of the electromagnet degaussing coil 10. A second function of the restraint channels 70A, 70B include the first set of restraint channel ribs 71A, 72A, 73A and the second set of restraint channel ribs 71B, 72B, 73B to limit outward movement of the wires. The outside surface of the electromagnet degaussing coil 10 is in contact with the ends of the first set of restraint channel ribs 71A, 72A, 73A and the second set of restraint channel ribs 71B, 72B, 73B. The generated magnetic flux fields of the electromagnet degaussing coil 10 move the magnet coil wires outward to apply a compressive force on the ends of the first set of restraint channel ribs 71A, 72A, 73A and the second set of restraint channel ribs 71B, 72B, 73B. The applied force to the first set of restraint channel ribs 71A, 72A, 73A and the second set of restraint channel ribs 71B, 72B, 73B is transferred to walls of the restraint channels 70A, 70B.

In the illustrated embodiment, the thickness of the second restraint channel ribs 72A, 72B is larger than the thickness of the first restraint channel ribs 71A, 71B and the thickness of the third restraint channel ribs 73A, 73B. Thus, the contact surface area at the end of the second restraint channel ribs 72A, 72B that contacts the electromagnet degaussing coil 10 is larger than the contact surface area at the end of the first restraint channel ribs 71A, 71B and the contact surface area at the end of the third restraint channel ribs 73A, 73B. The larger contact surface area of the second restraint channel ribs 72A, 72B corresponds to the location where the magnetic flux fields of the electromagnet degaussing coil 10 are the greatest and produce the highest forces. The first restraint channel ribs 71A, 71B and the third restraint channel ribs 73A, 73B are in a location where the magnetic flux fields are lower, and the magnet wires exert a lower force on these same ribs. In some embodiments, the resulting force per unit area compressive stress of the first restraint channel ribs 71A, 71B, the second restraint channel ribs 72A, 72B, and the third restraint channel ribs 73A, 73B will be nearly equal.

In some embodiments, the outward force of the electromagnet degaussing coil 10 wires is transferred equally to walls of the first restraint channel 70A and the second restraint channel 70B through the corresponding ribs. The first restraint channel 70A may transfer that same force to the top support block 50 which in turn distributes the same force to the support bars 36A, 36B. In a likewise manner the second restraint channel 70B may transfer that same force to bottom support 52 which exerts the same force on the support bars 36A, 36B. The support bars 36A, 36B. are clamped tightly in place by the bolts 82A, 82B. The bending stress developed in the support bars 36A, 36B may be related to the distance between the bolts 82A, 82B. In some embodiments, the support bars 36A, 36B are made of a nonmagnetic 300-series stainless steel material of proper size to withstand the high bending stresses that are developed in high energy electromagnets.

Each paired set of support bars 36A, 36B is held in compression by the bolts 82A, 82B. The bolts 82A, 82B may be sized to resist the repulsive forces generated in the electromagnet degaussing coil 10. The bolt 82A extends through a support washer 83A, the bottom support bar 36B, the bottom support 52, first side support block 51, the top support block 50, and is then threaded into the top support bar 36A. The bolt 82B extends through a support washer 83B, an insulation sleeve 84, the top support bar 36A, the top support block 50, the second side support block 53, the bottom support block 52, and is then threaded into bottom support bar 36B. Eddy currents may develop in materials that are in near proximity to magnetic fields. In some embodiments, the insulation sleeve 84 is made from an electrically insulating material and is used to interrupt the path that these eddy currents may travel through in the circular path of the support bars 36A, 36B and the bolts 82A, 82B. The pairs or sets of support bars 36A, 36B are grounded to earth by common ground bar 37. A lock nut 85 is coupled to the end of each bolt 82 to prevent loosening caused from strong vibration developed in high energy electromagnets.

FIG. 11 depicts an end view of an electromagnet degaussing coil 86 with alternative configurations of air flow channels and support ribs. The electromagnet degaussing coil 86 has a first flat portion 87A (e.g., a top wire portion) and a second flat portion 87B (e.g., a bottom wire portion) spaced from and opposite the first flat portion 87A. The electromagnet degaussing coil 86 also has a first arched portion 88A on one end and a second arched portion 88B spaced from and opposite the first arched portion 88A. A top restraint channel 90 is disposed adjacent to and, in some configurations, in contact with the first flat portion 87A. A bottom restraint channel 94 is disposed adjacent to and, in some configurations, in contact with the second flat portion 87B.

The top restraint channel 90 includes a plurality of support ribs 92 that divide the top restraint channel 90 into a plurality of air passages 93. In some embodiments, the top restraint channel 90 includes nine support ribs 92 which form ten air passages 93. The operation of high electrical energy degaussing coils may involve support ribs 92 with more surface contact area between the ends of the support ribs 92 the wires of electromagnet degaussing coil 86. As a result of an increased number of the support ribs 92 (for example as compared with FIG. 8), the width and subsequently the cross-sectional area of the air passages 93 will be lower. To overcome the decrease in an area of the air passages 93, a rib height 91 is increased to allow more air flow.

The bottom restraint channel 94 includes variable width spacing between ribs. The bottom restraint channel 94 includes a plurality of ribs 89. The plurality of ribs 89 divide the bottom restraint channel 94 into first air passages 96, second air passages 97, and third air passages 98. A width of the second air passages 97 is greater than a width of the third air passages 98 and is less than a width of the first air passages 96. The ribs 89 form the barrier and external support structure between the second air passages 97 and the first air passages 96 position such ribs 89 in a location that provides suitable support for this region. A rib height 95 of bottom restraint channel 94 may be shorter due to the increased total cross-sectional area of all air passages 96, 97, 98.

When air passages in the bottom restraint channel 94 have a narrow width, the ribs forming such air passages provide increased support near the center of electromagnet degaussing coil 86. The highest magnetic flux fields may occur at the geometric center of electromagnet degaussing coil 86 and need greater external support. The positioning of more ribs near the center of second flat portion 87B is beneficial to increasing the external support strength. The benefits of a configuration like that of the bottom restraint channel 94 is increased external support in the region of highest repulsion forces occurring in the electromagnet degaussing coil 86 and an increased forced air cooling capacity from the larger total cross-sectional area of all air passages 96, 97, 98.

A side support 99 depicts a configuration that includes two ribs 99A that form three air flow passages. The two-rib configuration of the side support 99 may be beneficial for applications where the electromagnet degaussing coil 86 is externally supported and cooled. A rib height 100 of the side support 99 may be increased to offset the loss in air flow cross-sectional area cooling capacity caused by the ribs 99A.

Side support 101 depicts a configuration that includes one rib 101A that forms two air flow passage cooling regions. The one rib configuration of the side support 101 may be beneficial for application where high electrical energy electromagnets of the electromagnet degaussing coil 86 are being externally supported and cooled. A rib height 102 of the side support 101 may be of a shorter nature when only one rib is decreasing the air flow cross-sectional area cooling capacity. It is realized that the described configurations can be used in combination or with other configurations not described to provide a means to externally support and cool the external surface of an electromagnet degaussing coil.

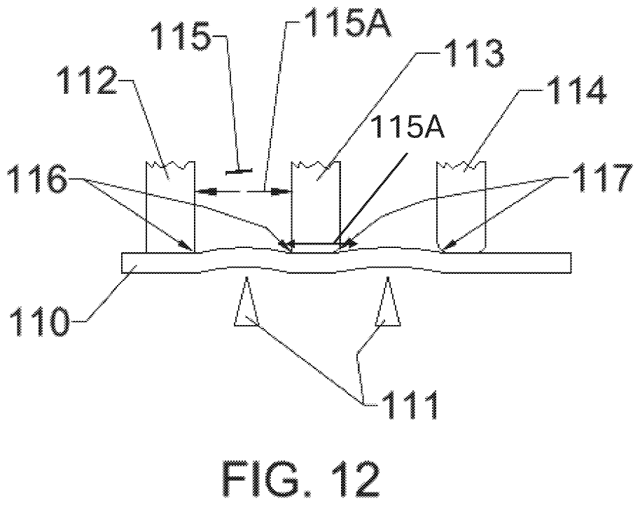

FIG. 12 illustrates an interaction of an electromagnet wire 110 of an electromagnet and ribs of a cooling channel, such as the restraint channels 70A, 70B of FIG. 8 or the restraint channels 90, 94 of FIG. 11. When electrical energy is applied to the electromagnet wire 110, the repulsive force created by the developed magnet flux fields may cause the electromagnet wire 110 to move in the direction 111 of shown by the arrows in FIG. 12. A plurality of ribs 112, 113, 114 are part of a restraint channel member (not shown in FIG. 12). The plurality of ribs 112, 113, 114 are separated by spaces 115 and have a separation distance 115A. When the plurality of ribs 112, 113, 114 are rigidly held in position as described herein, the electromagnet wire 110 moves in the direction 111 and into the spaces 115 between the plurality of ribs 112, 113, 114. When the ribs 112, 113, 114 have a sharp corner 116 or nearly sharp corners on a rib end that contacts the electromagnet wire 110, physical damage to wire insulation and magnet wire may occur. Thus, in some embodiments, the rib end that contacts the electromagnet wire 110 may have a rounded corner 117 to reduce chances of physical damage to the electromagnet wire 110.

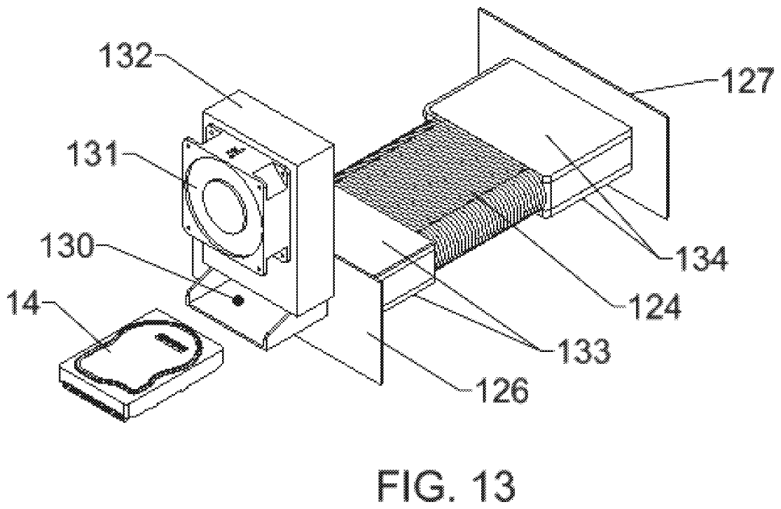

Turning to FIG. 13, in some embodiments, the electromagnet wire 110 of FIG. 12 is part of an electromagnet degaussing coil 124. The electromagnet degaussing coil 124 includes a media conveyance path 130 that extends through the center of the electromagnet degaussing coil 124. The media conveyance path 130 may include forced air cooling. The electromagnet degaussing coil 124 is held in position by a first restraint 133 and a second restraint 134. A fan 131 with a fan cavity 132 is coupled to the first restraint for generating air flow to pass over a portion of the electromagnet degaussing coil 124. The first restraint 133 is coupled to a first end panel 126. The second restraint 134 is coupled to a second end panel 125. In some configurations, the first end panel 126 and the second end panel 127 are part of a cover that houses or surrounds the electromagnet degaussing coil 124.

In a degaussing operation, a storage media 14 moves along the media conveyance path 130 from the entrance position shown in FIG. 13, through the center of the electromagnet degaussing coil 124 and to the opposite end of media conveyance path 130 where it is ejected. Air from the surrounding ambient air enters the fan 131 and moves into the fan cavity 132 where it is directed toward the media conveyance path 130. The fan cavity 132 directs the flow of cool air into the media conveyance path 130. The cool air flow passes through the center of the electromagnet degaussing coil 124.

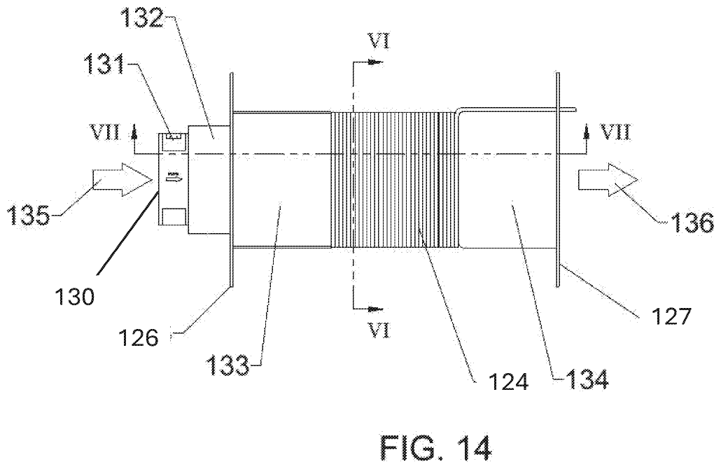

FIG. 14 shows a top view of the electromagnet degaussing coil 124 shown in FIG. 13. Cool ambient air enters the fan 131 in the location and direction of the arrow 135. The cool ambient air is moved into the fan cavity 132. The fan cavity 132 redirects the cool air flow and moves it in the direction of the electromagnet degaussing coil 124. The cool air flow continues through an internal volume of the electromagnet degaussing coil 124 and exits the media conveyance path 130 at an exit port 136. The media conveyance path 130 of FIG. 13 and the electromagnet degaussing coil 124 are supported by the first restraint 133 and the second restraint 134.

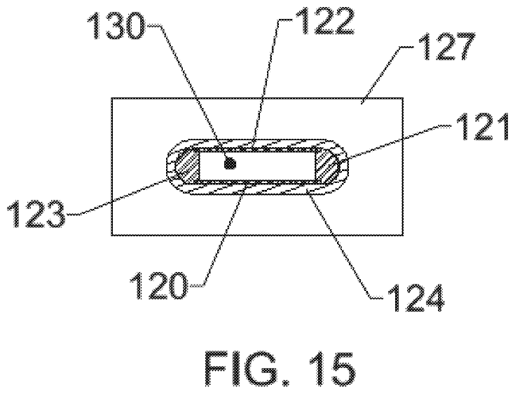

FIG. 15 that shows a section view taken along line “VI-VI” of FIG. 14. FIG. 15 shows the media conveyance path 130 in further detail. A bottom wall 120, a top wall 122, a first side wall 121 and a second side wall 123 border the media conveyance path 130. The bottom wall 120, a top wall 122, a first side wall 121 and a second side wall 123 define an inlet port 139 and an exit port 136 for a magnetic storage media passing through the media conveyance path 130. An internal height and an internal width of the media conveyance path 130 may be influenced or determined by the type of magnetic storage media that will be degaussed in the electromagnet degaussing coil 124. The bottom wall 120, the top wall 122, the first side wall 121 and the second side wall 123 form a rectangular shape that extends from the first end panel 126 (not shown, see FIG. 14) and the second end panel 127 uninterrupted. In some embodiments, the wires of the electromagnet degaussing coil 124 are wound around and in contact with an external surface of the bottom wall 120, the top wall 122, the first side wall 121 and the second side wall 123.

In some embodiments, the bottom wall 120, the top wall 122, the first side wall 121 and the second side wall 123 are made from a material type that is electrically insulating and non-conductive. Such materials generally have a low thermal conductivity rating. To overcome the low thermal conductivity, a thickness of the bottom wall 120 and the top wall 122 may be reduced or minimized to improve cooling effects. In some embodiments, the bottom wall 120 and the top wall 122 are made from glass-reinforced epoxy laminate material, such as an FR-4 type of material. In some embodiments, the bottom wall 120 and the top wall 122 are less than about 1 inch thick and, in some aspects, are about ⅛-inch thick.

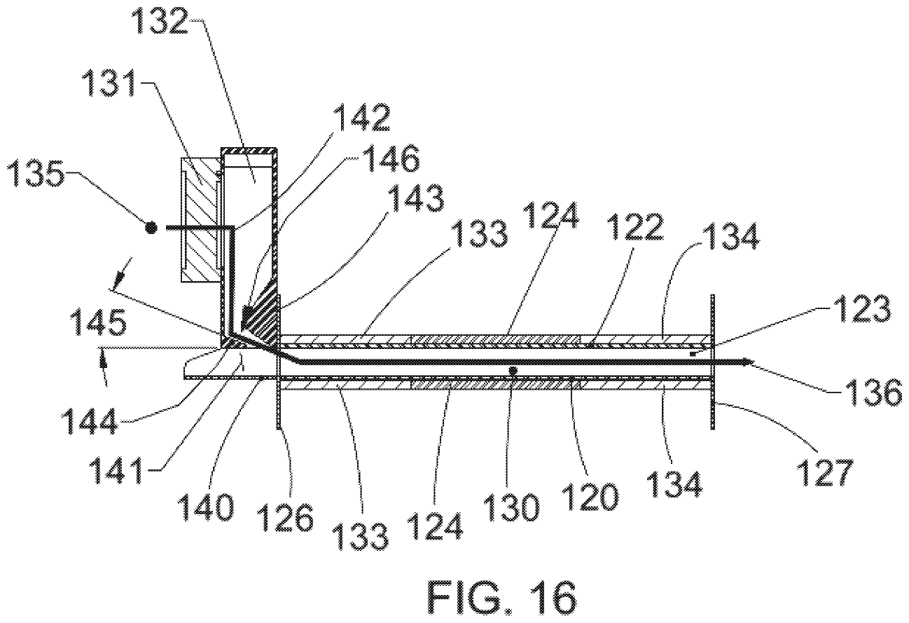

FIG. 16 is a section view taken along line “VII-VII” of FIG. 14. FIG. 16 illustrates the air flow path used to cool the internal surfaces of the electromagnet degaussing coil 124. The wires of the electromagnet degaussing coil 124 are wound around and supported by the bottom wall 120, the top wall 122, the first side wall 121 and the second side wall 123. The bottom wall 120, the top wall 122, the first side wall 121 and the second side wall 123 are coupled to the first end panel 126 and the second end panel 127. The bottom wall 120, the top wall 122, the first side wall 121 and the second side wall 123 border the media conveyance path 130. A media entrance chute 140 is disposed at a first end (e.g., an entrance end) of the media conveyance path 130 adjacent to the first end panel 126. An exit port 136 is disposed at a second end (e.g., an exit end) of the media conveyance path 130 adjacent to the second end panel 127. The fan 131 and, in particular, the fan cavity 132, is disposed adjacent to the media entrance chute 140 and, in some embodiments, the fan cavity is coupled to the first end panel 126 adjacent to the media entrance chute 140.

The media entrance chute 140 is coupled to the first end panel 126. The media entrance chute 140 is also coupled to the media conveyance path 130 and provides a location for a magnetic storage media to enter the media conveyance path. In some embodiments, the media entrance chute 140 is a “U” shaped channel that has a bottom surface and two side surfaces. The bottom surface of the media entrance chute 140 serves as a platform on which the magnetic storage media can slide and also serves as an air flow diverting surface. The sides of the media entrance chute 140 may function as air flow retaining barriers and direct the air flow into the media conveyance path 130. In some embodiments, a media entrance height 141 is equal to the height of media conveyance path 130 and is equal to a distance from the bottom surface of the media entrance chute 140 to the bottom edge of fan cavity 132.

The fan cavity 132 includes a first cavity diverter 143 and a second cavity diverter 144. Together, the first cavity diverter 143 and the second cavity diverter 144 define an air flow opening 146. In some embodiments, the air flow opening 146 is disposed at an angle 145 relative to the media conveyance path 130 (e.g., relative to horizontal). In some embodiments, the angle 145 of the air flow opening 146 about 20 degrees relative to the media conveyance path 130. The angle 145 of the air flow opening 146 may be in the range of about 5 degrees to 45 degrees relative to the media conveyance path 130. When the angle 145 is above about 45 degrees, internal surface cooling effectiveness above the electromagnet degaussing coil 124 may decay.

In operation, the fan 131 pushes the ambient air 135 into an internal volume of the fan cavity 132 of the fan 131. The ambient air 135 from the fan 131 travels along an air flow path 142 that moves air inside of the fan cavity 132 downward and through an opening formed by the first cavity diverter 143 and the second cavity diverter 144. The air flow from the air flow path 142 is discharged from the air flow opening 146 in the fan cavity 132 and is directed into the media conveyance path 130 and continues in the direction of the exit port 136. As air flow from the air flow path 142 traverses through the media conveyance path 130 it contacts the surface of the bottom wall 120 and the top wall 122 where the flow extracts heat energy from the electromagnet degaussing coil 124. Heat energy conducts through the material thickness of the bottom wall 120 and the top wall 122. The air flow from the air flow path 142 that exits out of the electromagnet degaussing coil 124 region may be warm. The air flow from the air flow path 142 continues in the direction of the exit port 136, where it is released back into the surrounding ambient environment.

FIG. 16 is illustrated as an open cavity passthrough style electromagnet degaussing mechanism. In some approaches, the described internal cooling embodiment may also be incorporated into a closed cavity non-passthrough style electromagnet degaussing mechanism. It is realized that media conveyance path 130 serves multiple functions that include providing a passageway for the magnetic storage media 14 (see FIG. 13) also providing the air flow path 142 for cooling. In the illustrated embodiment, the magnetic storage media 14 travels in the direction of the air flow path 142. In other embodiments, the magnetic storage media 14 may travel in a direction opposite that of the air flow path 142.

The embodiments in FIGS. 1-16 describe cooling the electromagnet degausser coils using air (e.g., ambient air) as a cooling fluid. However, it is to be understood that other fluids such as refrigerant gases can be used as the cooling fluid in the apparatuses shown and described with references to FIGS. 1-16. Suitable refrigerant gases include but are not limited to fluorocarbon gases such as chlorofluorocarbons (CFCs), hydrochlorofluorocarbons (HCFCs), hydrofluorocarbons (HFCs), ammonia, carbon dioxide, nitrogen, helium, or other inert gases. Use of a fluid other than air may include a heat-exchanger type device disposed between the exhaust adapter 35A and the inlet fan 32 (see FIG. 2) to create a closed loop system. Such a closed loop system configuration may be used for external surface wire cooling rather than for internal cavity cooling as is shown in FIGS. 13 and 16.

In some aspects, a method for cooling a degausser coil includes enclosing, at least partially, an electromagnet degaussing coil within an internal cavity of a cover and positioning a first restraint and a second restraint in the internal cavity. The first restraint comprises a first restraint body with a first set of restraint ribs extending therefrom. The first restraint is positioned in the internal cavity between the cover and a first portion of the electromagnet degaussing coil such that the first restraint body is spaced from the first portion to form a first restraint channel with the first set of restraint ribs extending through the first channel. The first set of restraint ribs are positioned to resist repulsive forces generated by the electromagnet degaussing coil. The second restraint comprises a second restraint body with a second set of restraint ribs extending therefrom. The second restraint is positioned in the internal cavity between the cover and a second portion of the electromagnet degaussing coil such that the second restraint body is spaced from the second portion to form a second restraint channel with the second set of restraint ribs extending through the second channel. The second set of restraint ribs are positioned to resist repulsive forces generated by the electromagnet degaussing coil. The method further includes supplying a cooling fluid to the first channel and the second channel via a fan to cool the electromagnet degaussing coil.

In some embodiments, the first restraint is the first restraint 150A that is shown and described with reference to FIGS. 7 and 8 and the second restraint is the second restraint 150B that is shown and described with reference to FIGS. 8 and 9. Further, the fan may be the fan 32 that is shown in and described with reference to FIGS. 2-10.

In some embodiments, the method further includes diverting the cooling fluid from the fan towards at least one of the first channel or the second channel. The cooling fluid may be diverted, for example, using a diverter that is disposed in the internal cavity of the cover. The diverter can include one or more diverters such as the inlet diverter 45, the top diverter 57, or the bottom diverter 58 that are shown and described with reference to FIG. 4A.

In some embodiments, the cooling fluid is at least one of ambient air or a refrigerant gas.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B. Similarly, the word “or” when used herein shall be interpreted as having a disjunctive construction rather than a conjunctive construction unless otherwise specifically indicated.

The singular forms “a”, “an”, and “the” include plural references unless the context clearly dictates otherwise.

The terms and expressions used herein have the ordinary technical meaning as is accorded to such terms and expressions by persons having ordinary skill in the technical field as set forth above except where different specific meanings have otherwise been set forth herein. The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. An apparatus for cooling electromagnet degaussing coils, the apparatus comprising:
a cover including an outer casing and an inner casing, the outer casing coupled to and spaced from the inner casing to define an internal cavity therebetween, the inner casing forming a media conveyance path that extends through the cover, the internal cavity including:
an electromagnet degaussing coil for erasing a media passing through the media conveyance path, the electromagnet degaussing coil includes a first portion and a second portion disposed opposite the first portion;
a first restraint disposed between the first portion of the electromagnet degaussing coil and the cover, the first restraint comprising a first restraint body that is spaced from the electromagnet degaussing coil to form a first restraint channel, the first restraint including a first set of restraint channel ribs to resist repulsive forces generated by the electromagnet degaussing coil; and
a second restraint disposed between the second portion of the electromagnet degaussing coil and the cover, the second restraint comprising a second restraint body that is spaced from the electromagnet degaussing coil to form a second restraint channel, the second restraint including a second set of restraint channel ribs to resist repulsive forces generated by the electromagnet degaussing coil; and
a fan mounted in fluid communication with the first restraint channel and the second restraint channel for cooling the electromagnet degaussing coil.

2. The apparatus of claim 1, wherein a number of ribs in the first set of restraint channel ribs is the same as a number of ribs in the second set of restraint channel ribs.

3. The apparatus of claim 1, wherein at least a portion of the electromagnet degaussing coil is disposed around the media conveyance path.

4. The apparatus of claim 1, wherein the electromagnet degaussing coil has inside surfaces disposed on an inner side of the electromagnet degaussing coil and outside surfaces disposed on an outer side of the electromagnet degaussing coil, and wherein at least a portion of the inside surfaces are in direct contact with the inner casing of the cover and wherein at least a portion out the outside surfaces are in direct contact with the first restraint and the second restraint.

5. The apparatus of claim 1, wherein the first portion is a first flat portion and the second portion is a second flat portion, and wherein the first portion and the second portion are coupled to a first arched portion and a second arched portion, the second arched portion spaced from and opposite the first arched portion.

6. The apparatus of claim 5, wherein the internal cavity of the cover further includes a channel disposed adjacent to the first arched portion of the electromagnet degaussing coil for directing fluid flow from the fan along the first arched portion.

7. The apparatus of claim 6, further comprising:
an inlet diverter disposed in the internal cavity adjacent to the fan, the inlet diverter includes an edged body comprising a first incline surface for directing fluid flow from the fan to a first portion of the electromagnet degaussing coil and a second incline surface for directing fluid flow from the fan to a second portion of the electromagnet degaussing coil.

8. The apparatus of claim 7, wherein the first incline surface and the second incline surface are faces of a triangular prism.

9. The apparatus of claim 7, wherein the inlet diverter further includes an arcuate body that includes a curved surface for directing fluid flow from the fan through the channel disposed adjacent to the first arched portion of the electromagnet degaussing coil.

10. The apparatus of claim 7, further comprising:
a top diverter comprising a planar panel with an incline surface that faces the fan.

11. The apparatus of claim 10, wherein at least a portion of the top diverter is disposed above the inlet diverter.

12. The apparatus of claim 7, further comprising:
a bottom diverter comprising a planar panel with an incline surface that faces the fan.

13. The apparatus of claim 12, wherein at least a portion of the bottom diverter is disposed below the inlet diverter.

14. The apparatus of claim 1, wherein the internal cavity of the cover includes a fan plenum that is in fluid communication with the fan and an exhaust plenum in fluid communication with an exhaust assembly.

15. The apparatus of claim 14, wherein the fan plenum is disposed adjacent to an inlet port of the media conveyance path, and wherein the exhaust plenum is disposed adjacent to an exit port of the media conveyance path.

16. The apparatus of claim 14, wherein the first restraint channel and the second restraint channel are in fluid communication with the fan plenum and the exhaust plenum, and wherein the first set of restraint channel ribs and the second set of restraint channel ribs extend from the fan plenum to the exhaust plenum.

17. The apparatus of claim 1, wherein the first restraint and the second restraint are made from a material that is at least one of electrically insulating, nonmagnetic, or nonthermally conductive.

18. A method for cooling degaussing coils comprising:
enclosing an electromagnet degaussing coil within an internal cavity of a cover;
positioning a first restraint comprising a first restraint body with a first set of restraint ribs extending therefrom in the internal cavity between the cover and a first portion of the electromagnet degaussing coil such that the first restraint body is spaced from the first portion to form a first restraint channel with the first set of restraint ribs extending through the first restraint channel to resist repulsive forces generated by the electromagnet degaussing coil;
positioning a second restraint comprising a second restraint body with a second set of restraint ribs extending therefrom in the internal cavity between the cover and a second portion of the electromagnet degaussing coil such that the second restraint body is spaced from the second portion to form a second restraint channel with the second set of restraint ribs extending through the second restraint channel to resist repulsive forces generated by the electromagnet degaussing coil; and
supplying a cooling fluid to the first restraint channel and the second restraint channel via a fan to cool the electromagnet degaussing coil.

19. The method of claim 18, wherein the cooling fluid is at least one of ambient air or a refrigerant gas.

20. The method of claim 18, diverting the cooling fluid from the fan towards at least one of the first restraint channel or the second restraint channel using a diverter disposed in the internal cavity.
